(19) United States
(12) Patent Application Publication
(10) Pub. No.: US 2001/0052112 A1
(43) Pub. Date: Dec. 13, 2001

(54) Method and apparatus for developing software

(76) Inventors: Ram P. Mohan, Cupertino, CA (US); Shariq Mansoor, Cupertino, CA (US)

Correspondence Address: WILSON SONSINI GOODRICH & ROSATI, 650 PAGE MILL ROAD, PALO ALTO, CA, 943041050

(21) Appl. No.: 09/808,741

(22) Filed: Mar. 14, 2001

Related U.S. Application Data
(60) Provisional application No. 60/189,358, filed on Mar. 14, 2000.

(51) Int. Cl. G06F 9/44

(52) U.S. Cl. 717/1

(57) ABSTRACT

A method for creating software provides a plurality of nodes and a directory of applications. Each application is created by use of at least a portion of the plurality of the nodes. At least a portion of the plurality of nodes are selected to create a selected node layout that represent a plurality of application logics. The selected node layout is executed by a server program.

### CLAIM OF PRIORITY

This application is a continuation-in-part of, and claims the benefit of Ser. No. 60/189,358, filed Mar. 14, 2000, which is fully incorporated herein by reference.

### BACKGROUND OF THE INVENTION

1. Field of the Invention

This invention relates generally to methods and apparatus for the development of software, and more particularly to a method and apparatus that includes at least one user interaction which is executable using a web, voice, e-mail or wireless channel

2. Description of the Related Art

The Internet has become a major channel for companies to conduct business. A wide range of business transactions including business to business, business to consumers, auctions, reverse auctions and vertical networks of businesses have driven growth. The unique aspects of this digital connectivity has spurred new forms of commerce transactions, eliminated geographic and time zone constraints, placed suppliers and customers in direct contact and essentially transformed the landscape of commerce. The speed of this transformation and the radical impact this has had on company fortunes has pushed businesses to rapidly recognize and re-engineer themselves, internally and externally with customers/suppliers, to get on the net.

The application of incorporating the web as a legitimate business channel has been a real struggle for most companies. Businesses have had to balance the pressures to ‘get on the net’ quickly against a long list of issues such as—what part of the company should get on the net first, how should this happen, developing an overall strategy for getting the entire company on the net, website design, connections to internal computer applications and applications, training, marketing/brand implications and significant ignorance of web technology and what e-commerce really mean. At one end of the spectrum, some companies have simply put up a website with basic company information (brochure-ware sites) and at the other end companies have defined and implemented comprehensive e-commerce strategies.

The complexities of defining what and how business will be conducted at the company website along with the intricacies of implementing the website and the myriad connections to internal applications has made the entire application extremely difficult to manage. A typical website implementation team consists of a few business domain experts but is largely dominated by web designers, content developers, database architects, middleware and other IT specialists. Given the large Web and IT focus on a typical e-commerce project, there is reduced emphasis on a clear definition of the business rules that must be implemented, disconnects between what the website implements and the required business application and most importantly, the inability of the website to respond quickly to business application/rule changes. This has resulted in companies changing business applications to accommodate website design and frustrated customers who do not understand the underlying business application and the critical connection between how the site must be used to get results.

There is a need for an efficient method for implementing websites based on clearly defined business rules and enable business objectives and business application capabilities to drive website implementation. There is another need for a method and apparatus creating software that eliminates the need for complex technical programming and maintenance for websites. There is a further need for a method and apparatus for creating software that defines complex business rules with a simple set of constructs.

### SUMMARY

An object of the present invention is to provide an improved method and apparatus for creating software.

Another object of the present invention is to provide a method and apparatus for creating software in order to implement websites based on pre-defined business rules enabling business objectives and to enable business application capabilities to drive website implementation.

Yet another object of the present invention is to provide a method and apparatus for creating software that eliminates the need for complex technical programming and maintenance for websites.

A further object of the present invention is to provide a method and apparatus for creating software that is based on complex business rules defined with a simple set of constructs.

A further object of the present invention is to provide a method and apparatus for creating software for implementing a website that separates the business application and rules design from the graphic design/look & feel design of the website.

Another object of the present invention is to provide a method and apparatus for creating software that implements websites by separating the execution of business rules on a server from the rendering of the user interface on client machines.

A further object of the present invention is to provide a method and apparatus for creating software that combines dynamically created content with a template module to create customized look and feel based on personalization and other considerations.

Another object of the present invention is to provide a method and apparatus for creating software that combines dynamically created content with a template module to enable a physical media independent web device driver.

Yet another object of the present invention is to provide a method and apparatus for creating software that separates nodes and links both at a conceptual level and as permanently stored objects.

Another object of the present invention is to provide a method and apparatus for creating software using selected node layouts that represent a plurality of application logics.

Yet another object of the present invention is to provide a method and apparatus for creating software that uses a user interaction which is executable on multiple channels.

A further object of the present invention is to provide a method and apparatus for creating software with a user interface that includes GUI components and a template for the physical layout of static and dynamic portions of a user display.

Another object of the present invention is to provide a method and apparatus for creating software using nodes that are visual representations of software functions.

Yet another object of the present invention is to provide a method and apparatus for creating software by creating application logic that is directly executed without compilation of the application logic.

These and other objects are achieved in a method for creating software. A plurality of nodes and a directory of applications are provided. Each application is created by use of at least a portion of the plurality of the nodes. At least a portion of the plurality of nodes are selected to create a selected node layout that represent a plurality of application logics. The selected node layout is executed by a server program.

In another embodiment, a method for creating software provides a plurality of nodes and a directory of applications. Each application is created by use of at least a portion of the plurality of the nodes. At least a portion of the plurality of nodes are selected to create a selected node layout that represent a plurality of application logics. The application logic is defined by selecting at least one of GUI parameters and options in each selected node. The selected node layout is executed by a server program.

In another embodiment of the present invention, a method for creating software provides a plurality of nodes and a directory of applications. Each application is created by use of at least a portion of the plurality of the nodes. At least a portion of the plurality of nodes are selected to create a selected node layout that represent a plurality of application logics. External application interfaces are defined. The selected node layout is then executed by a server program.

### BRIEF DESCRIPTION OF DRAWINGS

FIG. 1 is a flow chart illustrating one embodiment of the present invention using a solution engine that executes business application/rules defined in a knowledge base specified by analysts/online agents using a visual design tool.

FIG. 2 is a flow chart illustrating a specific business application that can be used with the present invention, and depicts the steps in diagnosing and recommending a work-around/solution for problems associated with a printer connected to a personal computer.

FIG. 3 is a flow chart that illustrates elements used to represent a business application and business rules - nodes and links used by the present invention.

FIG. 4 is a flow chart that represents an embodiment of the present invention where a application defined to assist in debugging problems with a specific model of a printer is reused and operates differently based on the context.

FIG. 5 illustrates the use of nodes and links to represent the business application shown in FIG. 2 and the applicationing sequence used by the solution engine.

FIG. 6 is a sample screen shot from a website that was generated using rules defined in FIG. 5.

FIG. 7 illustrates the mapping of node and template elements to the physical website display.

FIG. 8 illustrates a representative set of nodes, of the present invention, and their associated capabilities.

FIG. 9 is a schematic illustration of one embodiment of the display node and the display component of the present invention.

FIG. 10 illustrates one embodiment of a layout of a template and the application for website screen display generation of the present invention.

FIG. 11 illustrates how template based interaction of the present invention provides a method for user interactions to be defined and implemented independent of the physical characteristics of the user device.

FIG. 12 illustrates how template based interaction of the present invention enables personalization - to display user relevant content and user preferred display formats.

FIG. 13 is a flow chart that illustrates one embodiment of a methodology of the present invention for concurrent business application definition and web-site design.

FIG. 14 is a flow chart that illustrates one embodiment of the present invention of a complete view of applications and information flow using the FIG. 13 methodology.

FIG. 15 is a screen shot of an application builder screen.

FIG. 16 is a screen shot of a log-in into the application builder.

FIG. 17 is a screen shot of a new application node.

FIG. 18 is a screen shot of a menu display of the command options applicable to a selected node.

FIG. 19 is a screen shot of variables applicable to the selected node.

FIG. 20 is a screen shot illustrating variable attribute definitions for a selected variable of a node.

FIG. 21 is a screen shot that specifies the name of a variable.

FIG. 22 is a screen shot of a user interface node.

FIG. 23 is a screen shot of a user interface block node.

FIG. 24 is a screen shot that illustrates user interface block node properties.

FIG. 25 is a screen shot of a component definition box.

FIG. 26 is a screen shot of a variable definition box for a user interface block node.

FIG. 27 is a screen shot of a component definition box with a properties tab.

FIG. 28 is a screen shot of an interaction node.

FIG. 29 is a screen shot of the properties of an interaction node.

FIG. 30 is a screen shot illustrating an interaction node properties.

FIG. 31 is a screen shot of an application node menu to save a process.

FIG. 32 is a screen shot of a log-in function URL with basic fields.

FIG. 33 is a screen shot of an example of a task node.

FIG. 34 is a screen shot of a task node properties.

FIG. 35 is a screen shot of a step definition box.

FIG. 36 is a screen shot for selecting a step function.

FIG. 37 is a screen shot illustrating database variable interface options.

FIG. 38 is a screen shot illustrating mapping of database parameters.

FIG. 39 is a screen shot of a decision node.

FIG. 40 is a screen shot of a dialog box for a decision node properties.

FIG. 41 is a screen shot of a list of functions available at a decision node.

FIG. 42 is a screen shot of one of the functions of a DB list function.

FIG. 43 is a screen shot of a data node.

FIG. 44 is a screen shot of a list of functions available at a data node.

FIG. 45 is a screen shot illustrating node component function.

FIG. 46 is a screen shot of a do while loop node.

FIG. 47 is a screen shot of a loop application process.

FIG. 48 is a screen shot of a do while loop node's properties.

FIG. 49 is a screen shot of a list of the do while loop node's functions available.

FIG. 50 is a screen shot of a DB list functions available at the do while loop node.

FIG. 51 is a screen shot of an application node menu.

FIG. 52 is a screen shot of basic fields in the login process.

### DETAILED DESCRIPTION OF INVENTION

One embodiment of the present invention is a method for creating software with a plurality of nodes and a directory of applications. Each application is created by use of at least a portion of the plurality of the nodes. At least a portion of the plurality of nodes are selected to create a selected node layout that represent a plurality of application logics.

The application logic is automatically validated against errors by validating each node in the selected layout against a pre-defined set of parameters and values. At least a portion of the plurality of the nodes are aggregated to create an aggregated node which represents an application logic. Created aggregated nodes can be reused as part of other application logics by making it a child of another node in the selected layout.

The selected node layout is executed by a server program.

The application logic is directly executed without compilation of application logic. Each node in the selected node layout is stored in the database alone with all the selected parameters and parent child relationships. Once the selected node layout is stored in the server database, the server program extracts the selected node layout from the database and executes a single node at a time. At least a portion of the application logics includes a user interaction. The user interaction permits a user to interact with the server program and is executable on multiple channels including but not limited to web, voice, e-mail and wireless channels. The user interface provides a way for the server program to display information to the end-user and to allow the end-user to respond or direct the execution of the server program.

Each node is a visual representation of a software function and includes inputs to a software function. The plurality of nodes includes a variety of different nodes including but not limited to the following: application node, user interface node, interaction node, data node, task node, decision node, while loop node, do while loop node, transaction node, rollback node, asynchronous node and wait node. The application node is the root node and is used to define the global properties of the application, including but not limited to variables and constants. The application assigns a sequence of nodes and actions for a specific purpose.

Individual node execution measurements include usage counts, total execution time, average execution time and the like. A descriptive view provides details of the functional use of the selected layout. A history of different versions of the application logic is provided. Access control to the application logic permits a single access by only one user at a time for purposes of modification and multiple access for purposes of viewing.

The user interface node preferably has GUI components and a template for the physical layout of static and dynamic portions of a user display. Templates are HTML files that determine how the information identified in the User Interface, User Interface Block, and Interaction nodes is displayed. Templates provide the look and feel of user interaction.

Templates and template components are applied in the Interaction node and User Interface Block node components, respectively. Can apply a template to the Interaction node by assigning a template name as a value for the Template property. If you do not assign a value to the Template property, the default template will be applied.

Dynamic portions of the user display are used by the server program at run-time to layout application specific GUI components. At run-time the server program loads the defined template, dynamically generates the GUI component definitions and populates the dynamic portion of the template.

The user interface node, user interaction block and interaction node create a screen that is viewable by the user. The user interface block node is the child of user interface node and is used to create GUI components such as text or text boxes. The interaction node is used to display information to, receive information from, and send information to the user. It is also used to create an interaction using one or more user interface nodes.

The data node applications information and manipulates the data throughout the entire selected node layout, including but not limited to performing functions, tasks, evaluating expressions, assigning values to variables, embedding Java and the like. The task node interfaces with external systems or other applications based on predefined interface manager definitions. The decision node creates a condition or business rule within the user's application. The condition or business rule must be true or false in order for the application to move to the appropriate next step. If the condition or business rule is true, the application proceeds along “Path A” and along “Path B” when it is false. A loop is created by the while loop within the application as long as a certain condition remains true.

The while loop node checks the condition before beginning the loop. The do while loop is another node that creates a continuous loop within the selected node layout as long as a certain condition remains true. The do while loop is similar to the while loop except that it checks the condition after the first loop has been executed. The transaction node is used to mark the beginning of a transaction. Any children of the transaction node are included in the transaction. The transaction is rolled back if either a rollback node is encountered or any error occurs. The Rollback node is used for an explicit roll back of the transaction node and is a descendent of a transaction node. The asynchronous node is used to conduct a parallel execution of the child branch. The wait node is the parent node of the asynchronous node and waits until a specific condition is met or all child asynchronous nodes are done applicationing. Then, the rest of the application continues.

A node palette contains the user Interface, user interface block, interaction, data, task, decision, while loop, do while loop, transaction, rollback, asynchronous and wait nodes. The Application Diagram is the workspace for building applications. Nodes are added to the application by clicking and dragging the node type from the node Palette onto the application diagram. Properties for each node as needed by right-clicking on the node and entering information in properties dialog boxes. The application is then saved, tested and implemented.

Software programs that are created are organized in a hierarchical structure. A node palette lists the node types available for building the software application. Nodes are the building blocks for a application. Software developers use a application diagram as a workspace. Nodes are used to build applications. To create software, specific tasks that each node is to accomplish are defined and their sequence is established. Node properties include, (i) variables to store data with constant values, calculated values, or interactive result values, (ii) components that are defined within the user interface block node and used to present and collect information between the application and the user, (iii) expressions that define the values to be stored in the variables, including operators such as math functions, Boolean operators, date/time functions, and the like.

The look and feel of the user interface is created with the use of the user interface, user interface block and the interaction nodes. These nodes are used create the blank form, add information to that form, and then display the information to, and receive the information from, the software developer. These nodes define how the information is seen by the software developer. Templates are visual renditions of a user Interface node and can be designed in an external system.

The method and apparatus of the present invention can be used for defining a business application and associated business rules along with a corresponding user interface to generate a fully functional and scaleable website. Business rules are defined and a user interface created to deliver services, products and information over the Internet.

An operational website is created that implements these rules for use by website users using web browsers on client machines.

The business rules and the user interface elements are defined using a visual definition tool on a server machine. The business rules define all the services provided at the software consisting of business application elements such as global variables, applicationing elements, conditional elements and flow of control rules. The user interface elements and the methods to manifest these elements are kept separate—enabling enforcement of corporate look & feel standards, industry elements, frame-specific functions, personalization and device independence. The server system stores the business rules and the user interface elements in a repository and uses this to generate a website.

As customers and other users request services from this website, the server system uses the pre-defined business rules to analyze the customer's request, execute the corresponding business rule—which may consist of checking the user request/input with a backend system, performing some calculations—and based on the result perform a wide range of actions from simply serving up a specific user interaction or interfacing with an external application to exchange information and respond to the customer request. All of the interaction with the customer is performed using the user interface elements defined. These interface elements consist of a standard look and feel elements and also a set of user-definable display objects. Customers can define an attractive, engaging interface that is also powerful.

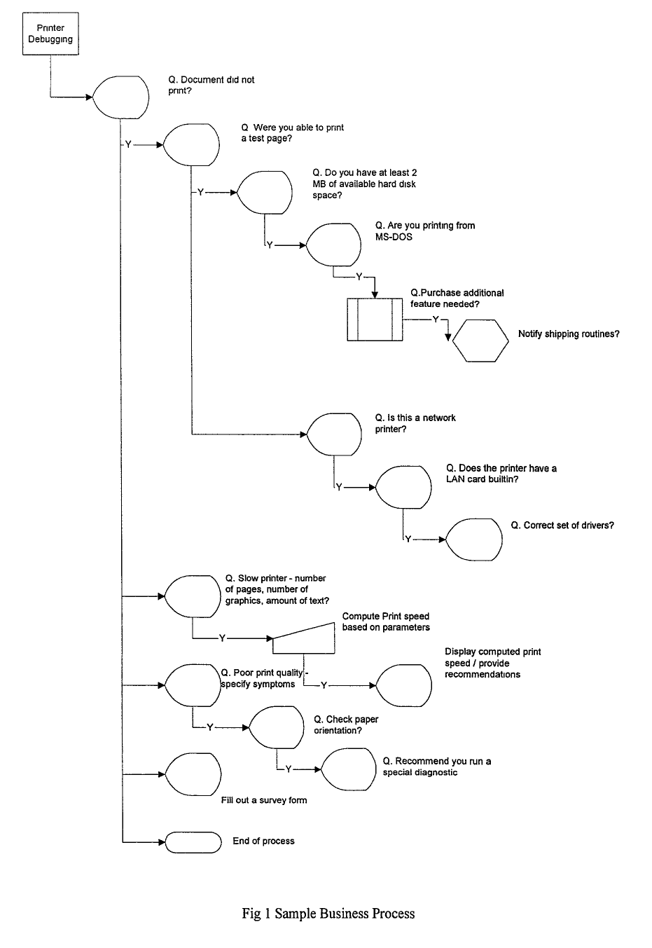

FIG. 1 provides an overview of the components of a complete website consisting of web servers connected on one side to the end-users via the Internet and on the other side to a backend complex comprising functional servers, interface routines and analyst/management tools. Specialized routines on the web servers interface with the solution engine using networked objects to track, control and manage user sessions. The solution engine, in turn, interfaces with specialized engines such as the observation, personalization and pricing engine as directed by specific nodes. A pool of standard interface routines is provided to allow the specialized engines and analyst/management tools to access databases, external applications and service providers.

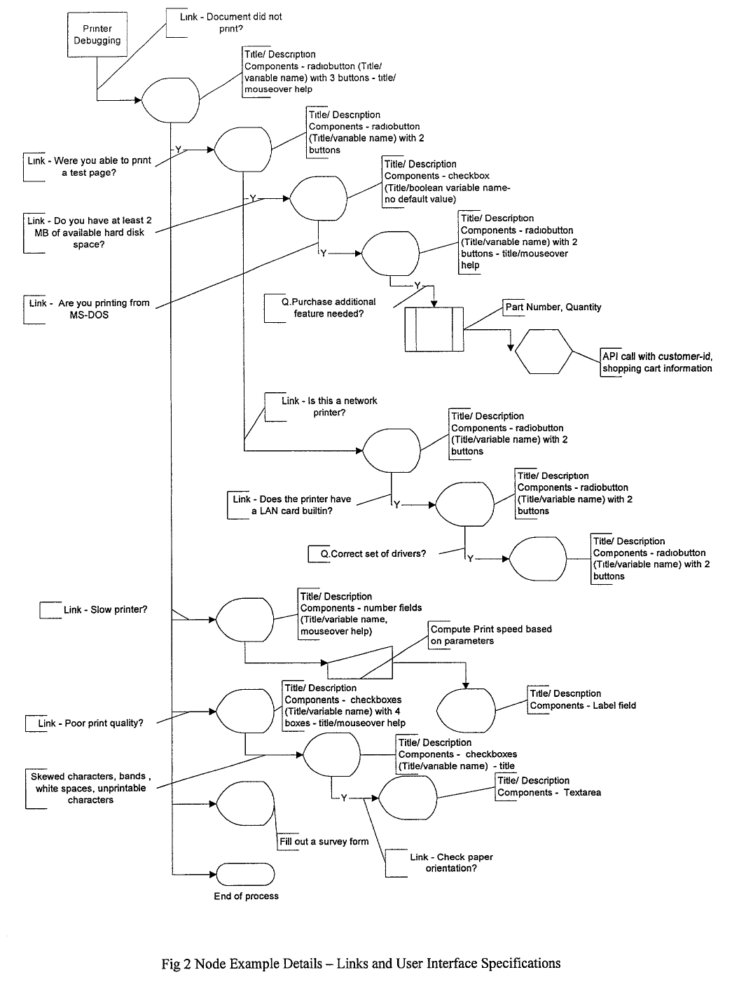

A representative business application is described in FIG. 2. In this instance, the sequence of steps describing the service application for a customer having a problem with a printer is shown and is typically what company service representatives would use. Key paths that are followed include, (i) functional checks, did the document print?, performance checks, is the printer printing slowly and (iii) quality checks, is the print quality poor.

In the functional track, the questions ‘were you able to print a test page’; ‘do you have at least 2 MB of available hard disk space’ focus on a missing piece of software that is downloaded/shipped once this is confirmed. A second path of diagnostic questions ‘is this a network printer’; ‘does the printer have a built-in LAN card’ is asked to identify an incorrect set of installed drivers. The next diagnostic path focuses on potential performance problems ‘is your printer printing slowly’ and verifies performance parameters to check against benchmarks and based on any identified anomalies recommends a course of action. The final diagnostic path focuses on quality-related issues ‘is your print quality poor’ and recommends some steps based on the specific quality issues identified. For each of these diagnostic paths, escalation to a specialist is recommended if any of the diagnostic questions results in a negative response.

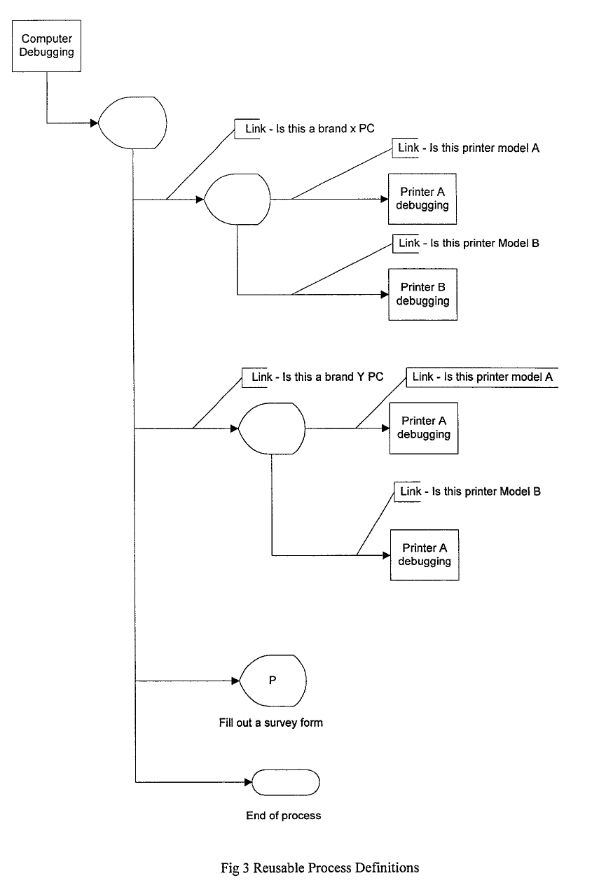

In one embodiment of the present invention, a visual design tool is used to layout the business application described in FIG. 2 along with additional information describing display elements, including but not limited to text, graphics and the like, used to interact with the end customer on a web browser. This is more fully shown in FIG. 3. These display elements can be specified directly or sketched out in a web page design tool and imported. Each of the nodes is connected to another via a link node that specifies a set of conditions that must be tested before a path is traversed.

Mapping between the business application is illustrated in FIG. 2. The website specification of FIG. 3 is almost identical except for the additional display content specific information. The application, rules and display content are stored in a knowledge base. At this point the website is fully operational and ready to application any requests relevant to this application.

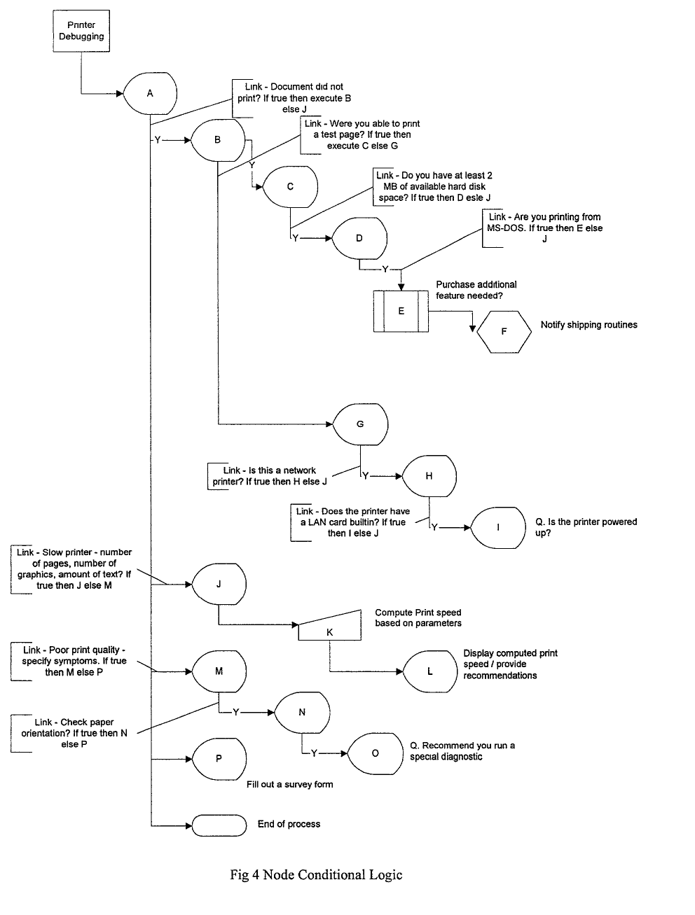

FIG. 4 represents a general application for assisting users with a range of PC-models configured with a range of printers. The diagnostic application for isolating and resolving problems with an ‘A’-model printer is shown being reused in multiple PC-type contexts. Based on the context of the invocation, the printer debugging application can be designed to operate differently.

A server system is used to implement the website and receives control when a client web browser issues a connection request to a specific pre-defined web page located on the server as shown in FIG. 1. This web page is associated with a specific application. When a client browser signals applicationing complete for this page, the server receives control and signals the solution engine with the application-id and any parameters passed from the client browser. The solution engine applications the tree of nodes and links associated with this application-id.

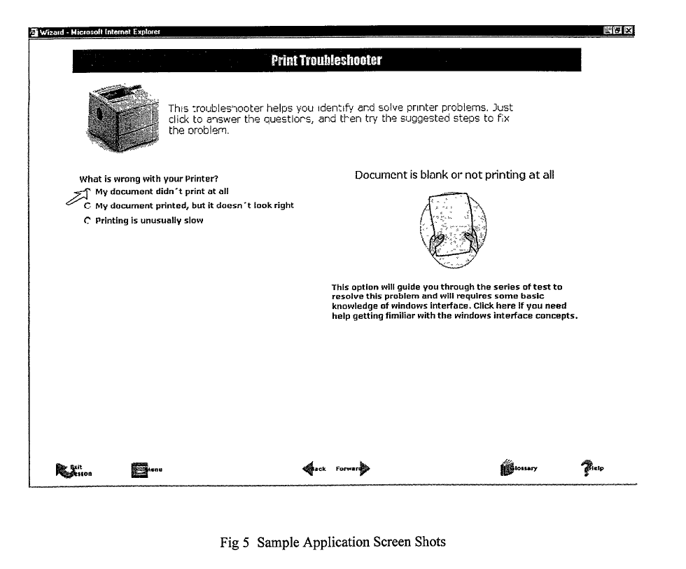

FIG. 5 illustrates the applicationing logic for the application defined in FIG. 2 and FIG. 3. Node A represents the first page displayed by the client browser and the link (Document did not print?) is tested. If this is tested true node B is applicationed; else the next link (Is the printer slow?) is evaluated. In general, the server system evaluates a link and if the condition is true applications the next node and its child nodes until it encounters a link that tests untrue or reaches the last node in a chain. When this happens, it reverses its execution path till it encounters a node that has a child on an untested path and tests the link on the path if one exists before applicationing the child node. Essentially, every path stemming from a node is tested before the server system continues on its reverse path. This is done until all paths have been traversed; at which point the server system deems the application completed.

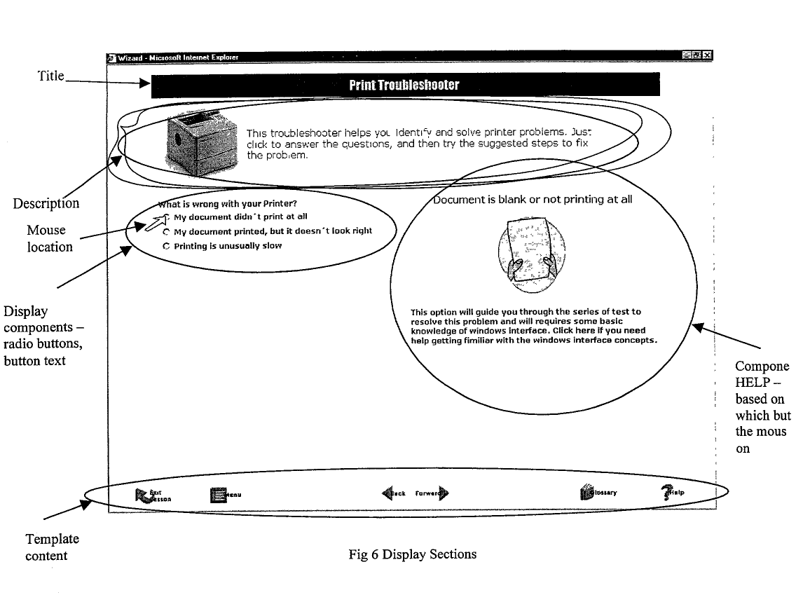

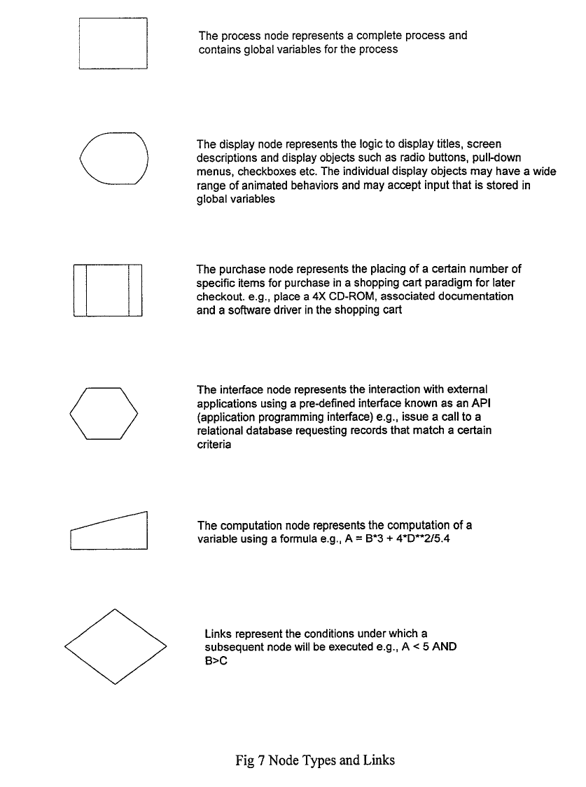

FIG. 6 illustrates a web page generated by the server system based on the application, rules and display specifications in FIG. 3. The server generates this page using display specifications in a template page and overlaying this with display components from the business application map, see FIG. 3. The title, description, display components and associated HELP are directly derived from the business application map. Positioning of the mouse pointer and the related HELP content pop-up are examples of the dynamic, content specific information that can be displayed. As the mouse moves over the other choices on FIG. 3, the component HELP associated with that choice is displayed.

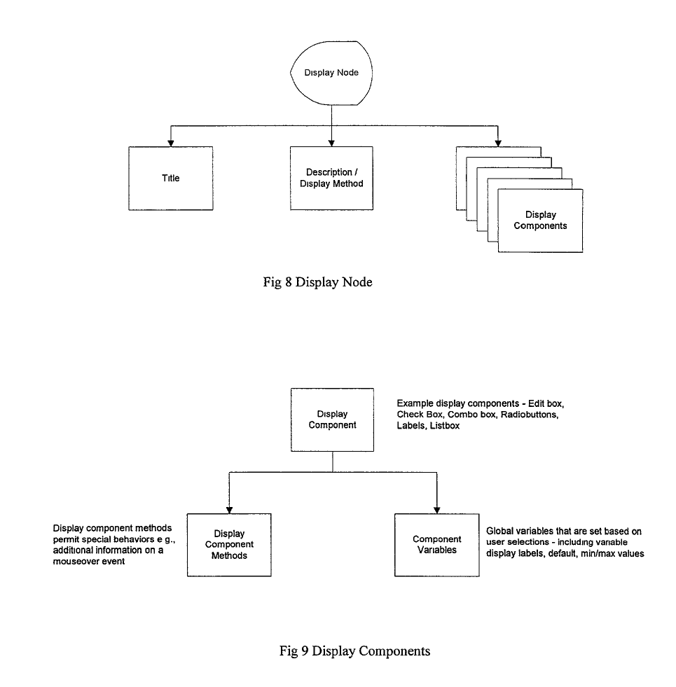

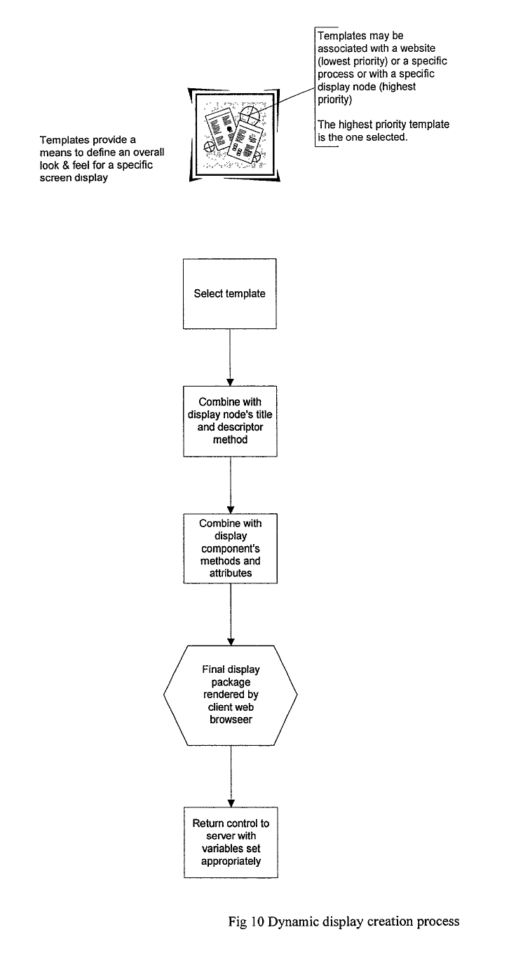

A basic set of building blocks for defining a website is shown in FIG. 8. These blocks include nodes that provide applicationing capability and links that test for conditions to enforce business rules. Based on the specific application being defined appropriate nodes are selected to represent the actual business application. Additional node types may be defined as needed. The display node represents an interaction with a web client browser and may be used to specify the content and layout of a web page. The structure of the display node, as shown in FIG. 9, consists of a foundation page consisting of static content (Title, Description) and display components that represent interactional elements used to display content and accept user input interactively. Display components as depicted in FIG. 10 consist of display widgets, associated content/text, HELP text and variables associated with the selection with defaults, min/max settings as appropriate. The defaults and min/max values can be set to variables as opposed to constants providing additional flexibility. The HELP text is, in one embodiment, displayed as a mouse rollover event.

Analysts using the visual design tool to layout a business application using display nodes can do so without any consideration of the physical device that will be used to interact with the web client. These display nodes are simply stored as text, content, widgets and HELP content in the knowledgebase.

Templates enable the physical manifestation of display nodes, which contain the logic and additional content. They use the data associated with the display node to interpret and convey text and content and most critically, they define the behaviors of the display components. This enables a display node to drive a web browser on a PC, or a web browser on a cellular phone or a conventional telephone dialed in to a Computer-Telephony-Integration enabled browser.

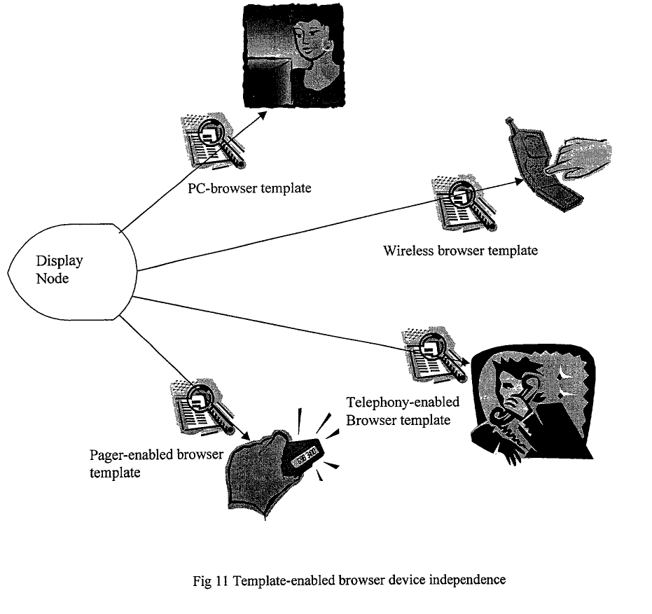

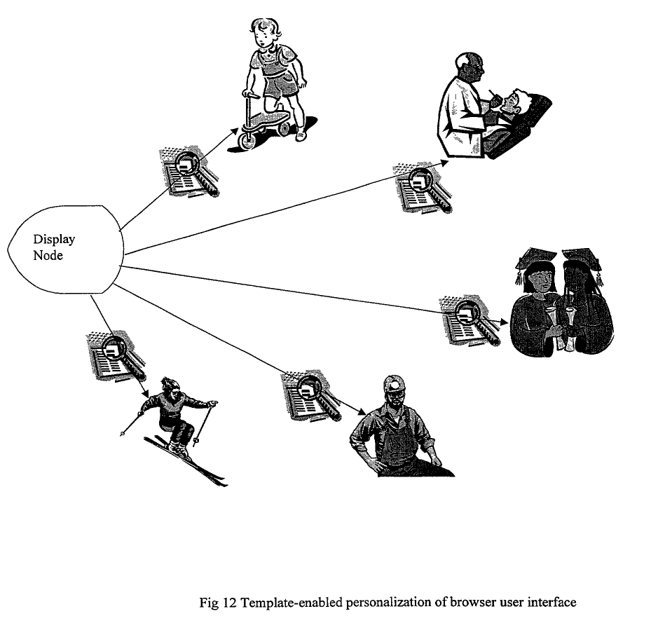

FIG. 11 illustrates the role of the template in the applicationing of interface nodes. Templates may be viewed as the engine that is fueled by the display node logic and contents. A single type of fuel (display node content), as in FIG. 12, drives many engines—cell-phone enabled browsers, telephones, and conventional PC-based browsers, handheld PDAs etc. Additionally, engines may be used to provide many forms of personalization (FIG. 12) based on the end customer - a regional, ethnic, professional look and feel.

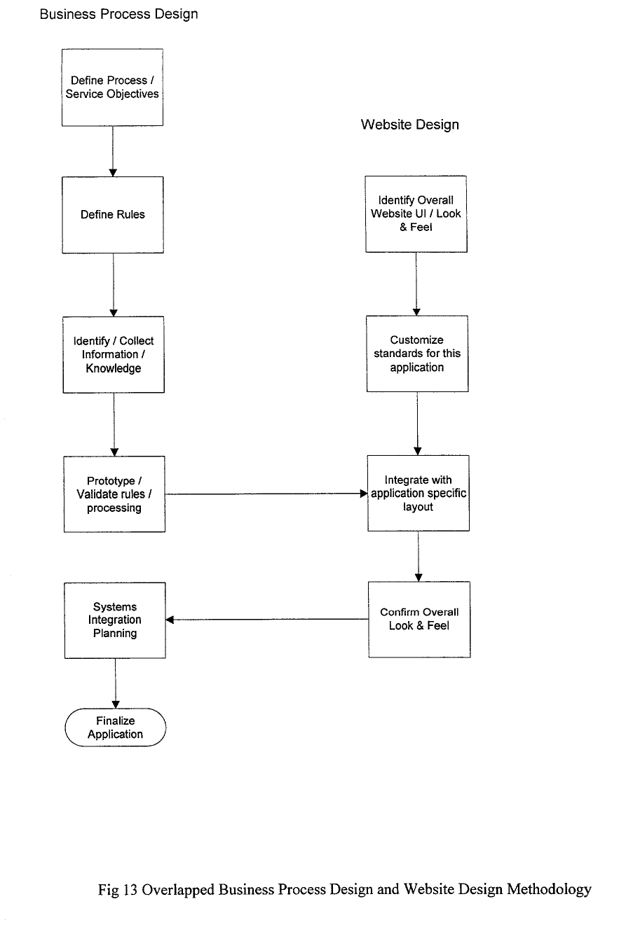

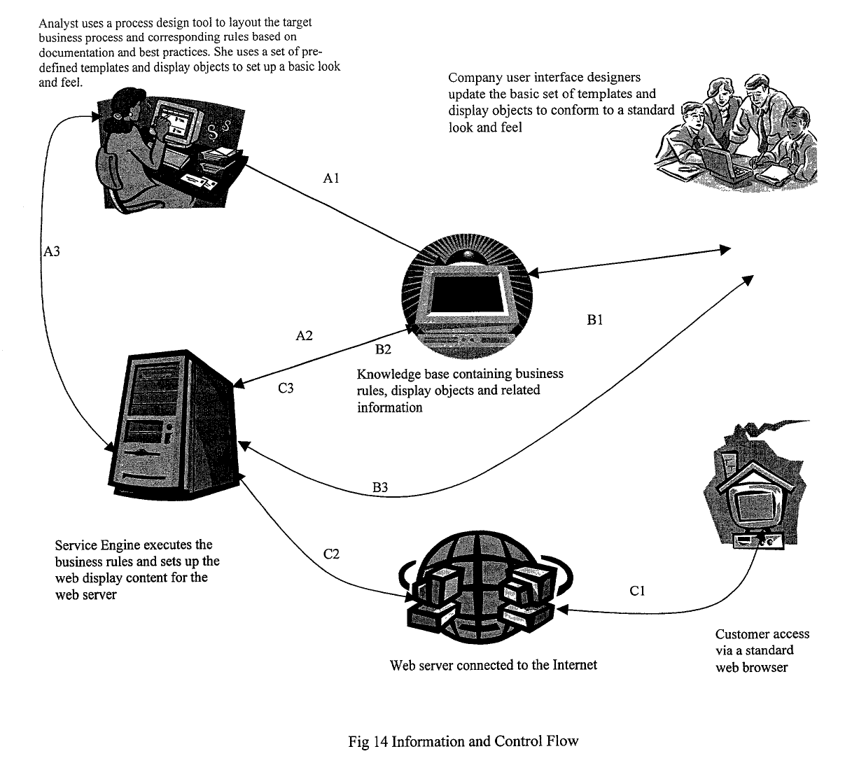

FIG. 13 illustrates a methodology that facilitates rapid implementation of website solutions. The delineation of business application and rules definition from the technical details of website user interface design are uniquely enabled by this invention. FIG. 14 illustrates the information flow in the three key use models for a website designed based on the principles described by the present invention.

### EXAMPLE 1

The following sections outline the steps taken to build a simple login application, which consist of:

Presenting an opening screen to the user.

Requesting the user ID and password.

Verifying the user ID and password.

Issuing an error message for incorrect logins.

### Summary

The following is a summary of the steps taken to complete a sample application:

Identifying A Application

Outlining the Application Sequence

Building a Application with Application Builder

Opening a Application

Step 1 Start Application Builder.

Step 2 Add a new category.

1 Right-click on the root Application node.

2 Select New Category.

3 Right-click the new Category folder.

4 Specify a name for the category.

5 Click OK.

Step 3 Select a new application to build.

1 Right-click on the category folder just created.

2 Select New Application.

Step 4 Check out the application for editing.

1 Right-click on the Application node.

2 Select Check Out.

Step 5 Name the Application.

1 Double-click on the Application node.

2 Type a title and name for the new application.

3 Click OK.

### Defining Variables

Step 1 Create variables.

1 From the Application node's properties dialog box, click the New button.

2 Type a name for each variable as it is added.

Step 2 Select the variable type.

1 Click on the Type column box.

2 Scroll through the list and select a type.

3 Click OK.

### Defining User Interaction

Step 1 Add a User Interface node.

1 Go to the Node Palette.

2 Add a User Interface node to the Application Diagram.

3 Double-click on the User Interface node.

4 Type a title and name for the new node.

5 Click OK.

Step 2 Add a User Interface Block node.

1 Go to the Node Palette.

2 Add a User Interface Block node to the Application Diagram.

3 Double-click on the User Interface Block node.

4 Type a title and name for the new node.

5 Click OK.

Step 3 Select a component.

1 Double-click on the User Interface Block node.

2 Double-click on a component type in the Available Component list.

Step 4 Define the component.

1 Type a title and name for the component.

2 Map a variable to the component.

3 Define additional variables as needed.

a Click the New button on the General tab.

b Enter the variable Name.

4 Select a User Interface type for the component.

a Click on the drop down list in the UI Type field.

b Choose one of the UI Type options.

5 Define properties for the component.

a Click on the Properties tab.

b Type in property values.

Step 5 Add an Interaction node.

1 Go to the Node Palette.

2 Add an Interaction node to the Application Diagram.

3 Double-click on the Interaction node.

4 Type a title and name for the new node.

5 Click OK.

Step 6 Map a User Interface node to the Interaction node.

1 Double-click on the Interaction node.

2 Select from the list of User Interface nodes.

3 Click Add.

Step 7 Define the Interaction node's properties.

1 Click on the Properties tab.

2 Type in property values.

3 Click OK.

Step 8 Verify the component display on the website.

1 Save the application.

a Right-click on the Application node.

b Select Save.

2 Find the Application node's ID.

3 Open a web browser.

4 Determine the Intranet path to the Application URL.

5 Specify the application ID found in SubStep 2b as the last six digits of the URL.

6 After review, return to the Application Builder.

### Defining the Database Information Used to Verify a Login

Step 1 Add a Task node.

1 Go to the Node Palette.

2 Add a Task node to the Application Diagram.

3 Double-click on the Task node.

4 Type a title and name for the new node.

5 Click OK.

Step 2 Add a Step to the Task node.

1 Display the Task node's properties dialog box.

2 Add a step.

Step 3 Define the Step function of the step.

1 Specify a name for the step.

2 Select a function for the step.

3 Select an interface.

Step 4 Create a DB List variable.

1 In the Interface area, click the New button.

2 Type a name for the DB List variable.

3 Select a Return Value from the drop down list.

4 Enter Input and Output parameters.

a Click on the Variable field for each Input and Output Column Name.

b Scroll through the list and select a variable.

### Setting Up for a Message Response

Setting Up a Condition

Step 1 Add a Decision node.

1 Go to the Node Palette.

2 Add a Decision node to the Application Diagram.

3 Double-click on the Decision node.

4 Type a title and name for the new node.

5 Click OK.

Step 2 Define the Decision node conditions.

1 Open the Decision node's properties dialog box.

2 Right-Click on the IF in the large text box.

3 Select one of the listed options.

4 Enter a Description.

5 Select a DBList variable.

6 Select an Operation.

7 Click OK.

### Setting Up Retry Attempts

Step 1 Add a Data node.

1 Go to the Node Palette.

2 Add a Data node to the Application Diagram.

3 Double-click on the Data node.

4 Type a title and name for the new node.

Step 2 Define the Data node.

1 Open the Data node's properties dialog box.

2 Create Rules for the Data Node.

a Click New in the Rules box.

b Select a Wizard.

c The Node Components Properties dialog box is displayed.

3 Enter a description.

Step 3 Map the component to the Data node.

1 Map the rule to the User Interface Block node.

2 Select a component.

3 Define the properties of the component.

a Enter text for the Caption property.

b Select a value for the Visible property.

c Click Apply.

d Click OK.

4 Check the new rule.

### Defining a Loop

Step 1 Add a Loop node.

1 Select a type of Loop node.

2 Go to the Node Palette.

3 Add a Do While Loop node to the Application Diagram.

a Drag the Do While Loop node over the intended parent node.

b Move the branch that will make up the loop application into the position of the Do While Loop node's children.

i Copy the branch.

ii Paste the branch.

iii Remove the old branch.

iv Reactivate the User Interface node in the Interaction node.

4 Double-click the Do While Loop node.

5 Type a title and name for the new node.

6 Click OK.

Step 2 Define the Do While Loop node's conditions.

1 Open the Do While Loop node's properties dialog box.

2 Right-click on the DO WHILE in the large text box.

3 Select one of the listed options.

4 Enter a description.

5 Select a DBList variable.

6 Select an Operation.

7 Click OK.

### Saving the Application

Step 1 Save the application.

1 Complete the application.

a Right-click on the Application node.

b Select Save.

2 Find the Application node's ID.

### Testing the Application

Step 1 Verify the application display on the website.

1 Open a web browser.

2 Determine the Intranet path to the Smart eBusiness URL.

Specify the application ID number found in SubStep 2b as the last six digits of the URL.

For purposes of this specification, a application is a sequence of events, organized in a collection of nodes and variables, that define how to conduct business. A application can be an internal procedure or a customer interaction. Prior to building a application a software developer determines:

The objectives of the application.

User levels, input, and response.

Data requirements.

Applicationing steps.

Constraints.

The order of application events.

Building a application is a collective activity that includes:

Defining the needs of the application.

Storyboarding or outlining the planned flow of the application.

Using Application Builder, proceeding by:

Selecting an existing application or creating a new application from the Application directory.

Checking out the application from the Application Diagram.

Adding nodes to the application by clicking and dragging the node type from the Node Palette onto the Application Diagram.

Defining the properties for each node as needed by right-clicking on the node and entering information into the properties dialog boxes.

Saving the application.

Testing the application.

Executing the application by specifying the unique application identification in the URL of a web browser.

When a application is built using Application Builder, the activities include:

Checking out a application for editing.

Defining variables for the login application.

Defining the interaction between the user and the application -how the user will supply the login information.

Defining what database information will be compared to the user login information.

Defining steps for an incorrect login:

Setting up an error message response.

Setting up a condition.

Setting up retry attempts.

Defining a loop to cycle through login and verification.

Defining action to be taken through a login retry loop.

Saving the login application.

Testing the login application.

Executing the login application.

### Opening a Application

A application can be opened by either double-click an existing application or opening a new application from the Application directory. All applications must be checked out from the application diagram area to enable editing.

Step 1 Start Application Builder.

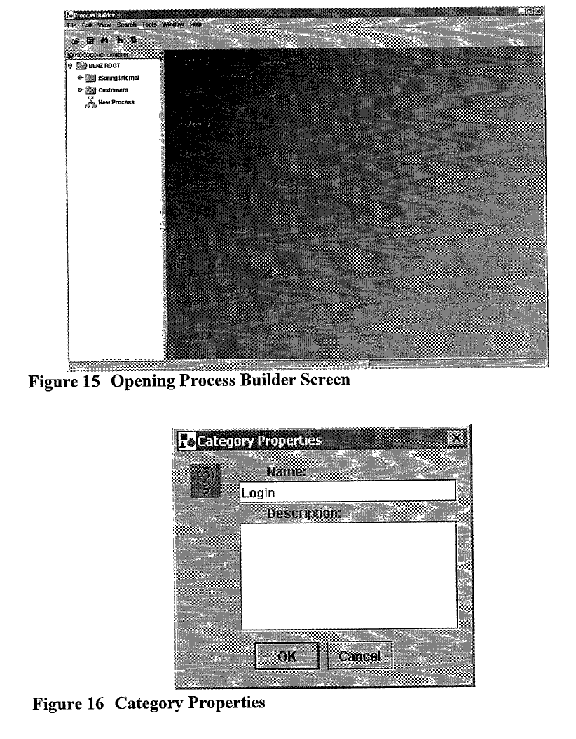

The Application directory is displayed with the root Application node and any other applications that are defined. See FIG. 15.

Step 2 Add a new category.

The Category folders are for organizational purposes only and are not required for building a application.

1. Right-click on the root Category.

A menu is displayed.

2. Select New Category.

A new Category folder is added to the Application directory.

3. Right-click the new Category folder.

### Select Properties.

The new Category's properties dialog box is displayed.

4. Specify a name for the category and a description, if needed.

The sample is named Login. See FIG. 12-2.

5. Click OK.

The category folder is now labeled with the new name.

Step 3 Select a new application to build.

1. Right-click on the category folder that was just created.

A menu is displayed.

2. Select New Application.

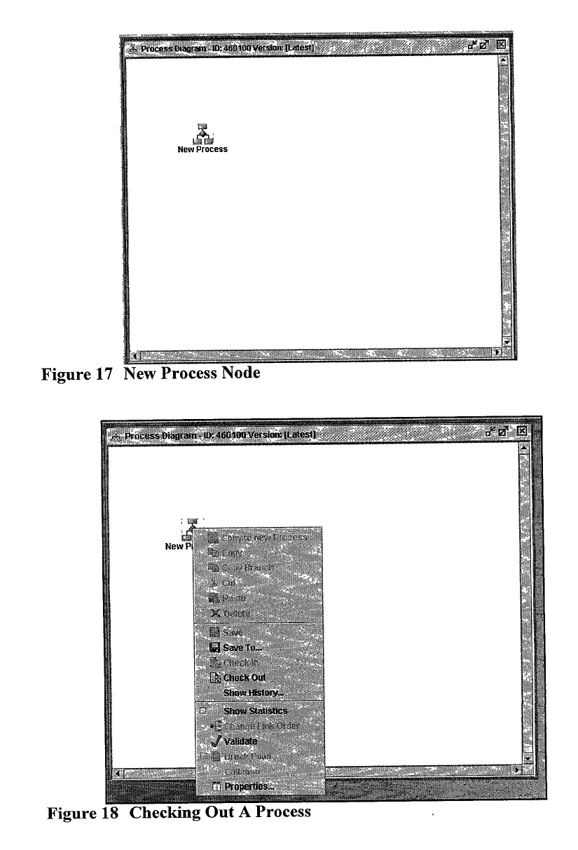

A New Application node is displayed in the Application directory and in the Application Diagram. See FIG. 17.

Step 4 Check out the application for editing, if a previously created application is opened.

1. Right-click on the Application node.

A menu is displayed. See FIG. 18.

2. Select Check Out.

The application is now available for editing.

Note: If the application will be unavailable for editing if another user has checked it out.

Step 5 Name the Application.

1. Double-click on the Application node.

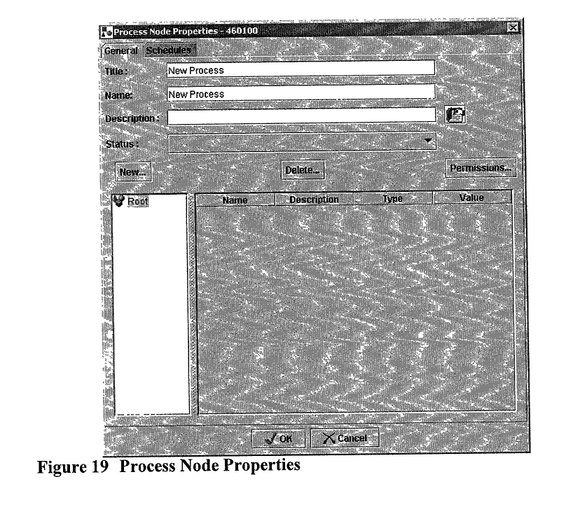

The Application node's properties dialog box is displayed. See FIG. 19.

2. Type a title and name for the new application.

The title will label the icons in the Application directory and Application Diagram. The name is used for internal purposes and will not be displayed. The name must be entered alphanumerically and without any spaces.

The sample title is Login Application, and the sample name is LoginApplication.

3. Click OK.

The properties dialog box is removed and the New Application title is updated in both the Application directory and Application Diagram areas.

### Defining Variables

Variables are the base data handling mechanisms in a application. This section describes how to create variables through the Application node.

Step 1 Create variables.

1. From the Application node's properties dialog box, click the New button.

A variable row is added to the variable list box.

2. Type a name for each variable.

In the sample, two variables are created: username and password.

Step 2 Select the variable type.

1. Click on the Type column box.

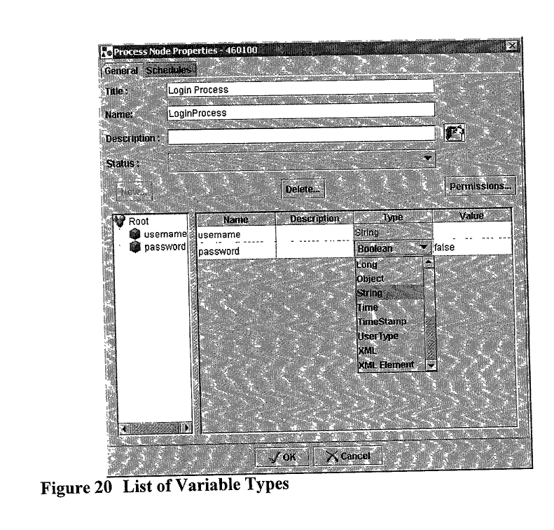

A list of variable types is displayed. See FIG. 20.

2. Scroll through the list and select a type.

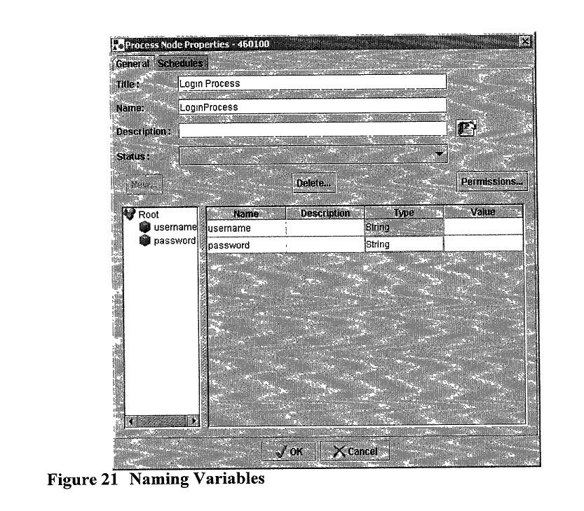

Default values for the Variable type appear in the Value field. In the sample, username and password are String type variables, and the default value is an empty field. See FIG. 21.

3. Click OK.

### Defining User Interaction

Step 1 Add a User Interface node.

1. Go to the Node Palette, if visible, or the selection of nodes displayed on the tool bar.

When the Node Palette is closed, the nodes are automatically displayed on the tool bar.

2. Add a User Interface Node to the Application Diagram.

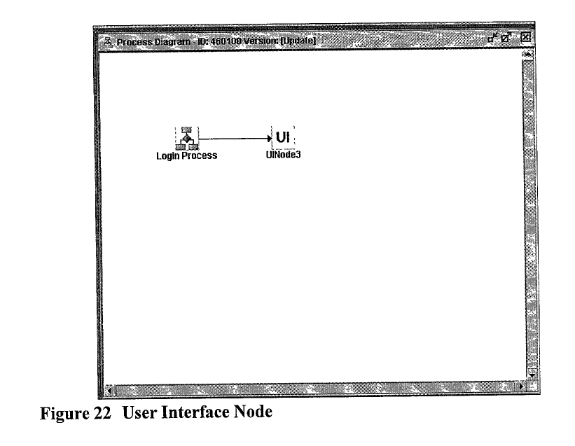

Click on the User Interface node and drag it over the intended parent node. In the sample, the Application node, labeled Login Application, is the parent node. See FIG. 22.

3. Double-click on the User Interface node.

The User Interface node's properties dialog box is displayed.

4. Type a title and name for the new node.

The sample title is Login Screen, and the sample name is LoginScreen.

5. Click OK.

Step 2 Add a User Interface Block node.

1. Go to the Node Palette, if visible, or the selection of nodes displayed on the tool bar.

2. Add a User Interface Block node to the Application Diagram.

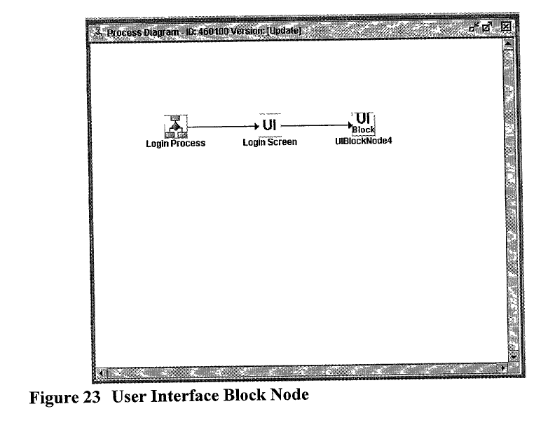

Click on the User Interface Block node and drag it over the intended parent node. In the sample, the User Interface node, labeled Login Screen, is the parent node. See FIG. 23.

3. Double-click on the User Interface Block node.

The User Interface Block node's properties dialog box is displayed.

4. Type a title and name for the new node.

The sample title is Login Controls, and the sample name is LoginControls.

5. Click OK.

Step 3 Select a component.

1. Double-click on the User Interface Block node.

The User Interface Block node's properties dialog box is displayed.

2. Double-click on a component type in the Available Components list.

The Component definition box is displayed with tabs labeled General, Properties, and Events.

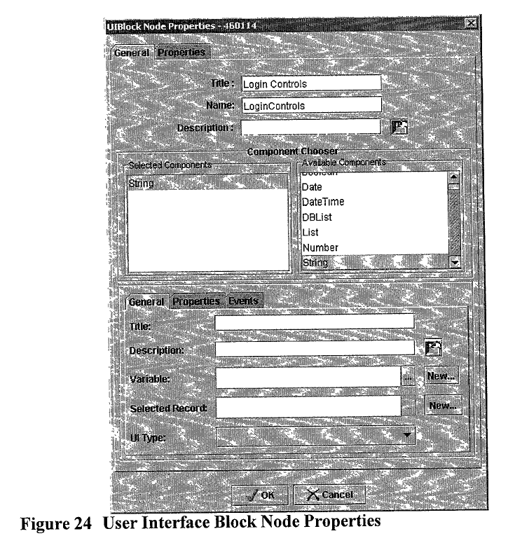

For the sample case, a String type component is selected. See FIG. 24.

Step 4 Define the component.

1. Type a title for the component.

The Title field is in the General tab of the Component definition box.

For the sample case the component label, UserName, is used.

2. Map a variable to the component.

Click on the drop down list in the Variable field.

This displays a list of defined variables that match the component type.

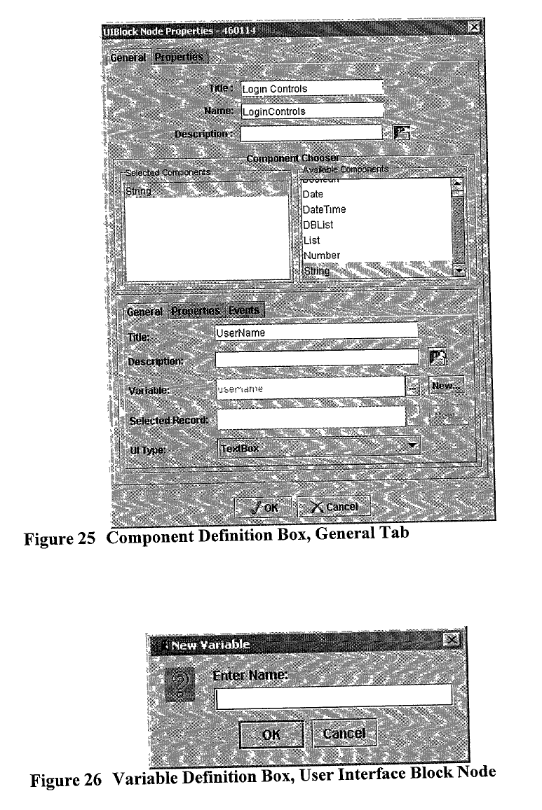

For the sample case, the username variable is selected. See FIG. 25.

3. Define additional variables as needed.

a. Click the New button on the General tab.

The Variable definition box is displayed. See FIG. 26.

b. Enter the variable Name.

The variable's type will be the same as the component's type.

For the example, the type is String.

4. Select a User Interface type for the component.

a. Click on the drop down list in the UI Type field.

A list of options is displayed.

b. Choose one of the UI Type options.

In the sample case, TextBox is chosen. See FIG. 25 above.

5. Define properties for the component.

a. Click on the Properties tab.

A list of properties is displayed in the left column, and a blank list of values appears in the right column.

b. Type in property values, or click on a drop down list and choose a property value.

When typing property values, make sure to press enter or the value will not be displayed.

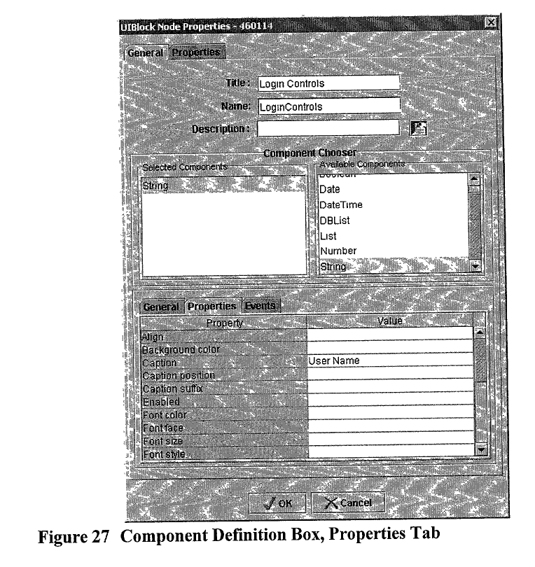

For the sample case, (see FIG. 27), the following values are set:

caption—User Name. This is the caption for the text box created by the username variable.

help text—Please enter a user id and password. This message will be displayed when the cursor is positioned over the User Name text box.

Note: For the sample case, a second component is created. Follow Steps 4 and 5 above to create another string component named Password. Map the component to the password variable. Select the TextBox UI type. Finally, set the properties: Password is entered as the caption property, and True is chosen for the password property.

Step 5 Add an Interaction node.

1. Go to the Node Palette, if visible, or the selection of nodes displayed on the tool bar.

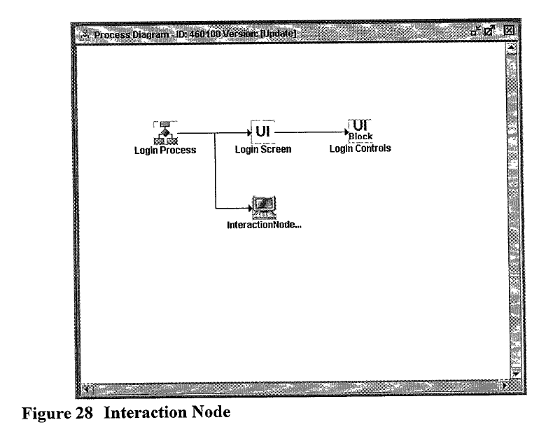

2. Add an Interaction node to the Application Diagram. Click on the Interaction node and drag it over the intended parent node. In the sample, the Application node, labeled Login Application, is the parent node. See FIG. 28.

3. Double-click on the Interaction node.

The Interaction node's properties dialog box is displayed.

4. Type a title and name for the new node.

The sample title is Login Interaction, and the sample name is LoginInteraction.

5. Click OK.

Step 6 Map a User Interface node to the Interaction node.

1. Double-click on the Interaction node.

The Interaction node's properties dialog box is displayed.

2. Select from the list of User Interface nodes.

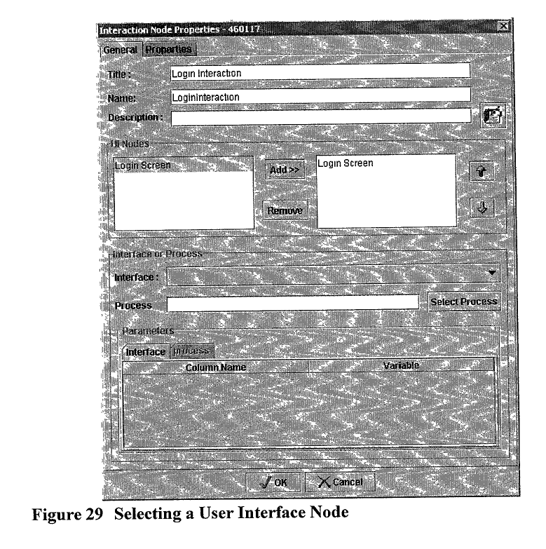

In the sample, the User Interface node titled Login Screen is selected. See FIG. 29.

3. Click Add.

The selected User Interface node will appear in the right column.

Step 7 Define the Interaction node's properties.

1. Click on the Properties tab.

A list of properties will be displayed in the left column, while a blank list of values will appear in the right column.

2. Type in property values, or click on a drop down list and choose a property value.

When typing property values, make sure to press enter or the value will not be displayed.

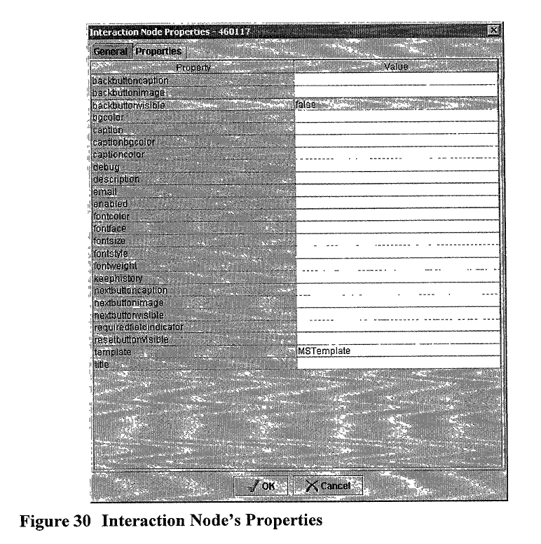

For the sample case, (see FIG. 30), the following values are set:

backbuttonvisible—false. This will prevent the back button from being displayed.

template—MSTemplate. This will display the MS Template.

3. Click OK

The Interaction node's properties are now set.

Step 8 Verify the component display on the website.

1. Save the application.

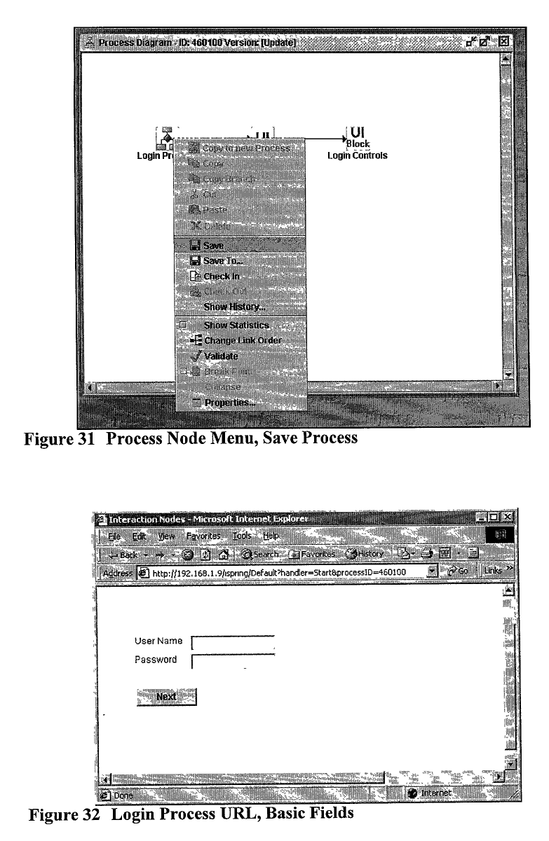

a. Right-click on the Application node. For the sample case, the Application node is labeled Login application. The Application node menu is displayed. See FIG. 31.

b. Select Save.

2. Find the Application node's ID.

Write down the ID that is displayed in the title of the Application Diagram.

3 . Open a web browser.

4. Determine the Intranet path to the Application URL.

A URL example is: http://192.168.1.9/ispring/Default?handler=Start&applicationlD=460100

5. Specify the application ID number found in SubStep 2b as the last six digits of the URL.

The application created thus far is displayed.

For the sample case, the two fields, User ID and Password, are displayed. See FIG. 32.

6. Once application the application, return to the Application Builder.

### Defining the Database Information Used to Verify a Login

All records related to the login application are stored in a database. To access the information in the database, a selection is made from pre-defined database interfaces created for a login in the Interface Manager. The following steps describe how to define what database information will be compared to the user login information.

Step 1 Add a Task node.

1. Go to the Node Palette, if visible, or the selection of nodes displayed on the tool bar.

2. Add a Task Node to the Application Diagram.

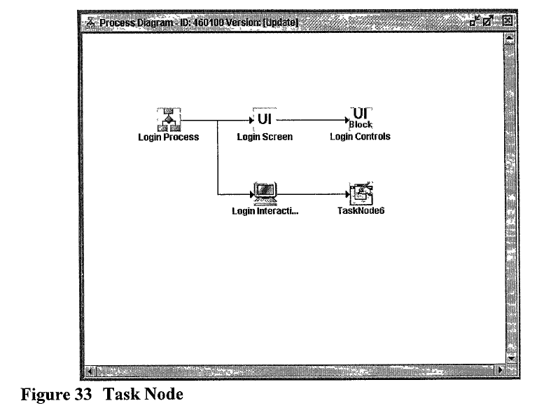

Click on the Task node and drag it over the intended parent node. In the sample, the Interaction node, labeled Login Interaction, is the parent node. See FIG. 33.

3. Double-click on the Task node.

The Task node's properties dialog box is displayed.

4. Type a title and name for the new node.

The sample title is Verify Login, and the sample name is VerifyLogin

5. Click OK.

Step 2 Add a Step to the Task node.

1. Display the Task node's properties dialog box.

Double-click on the Task node.

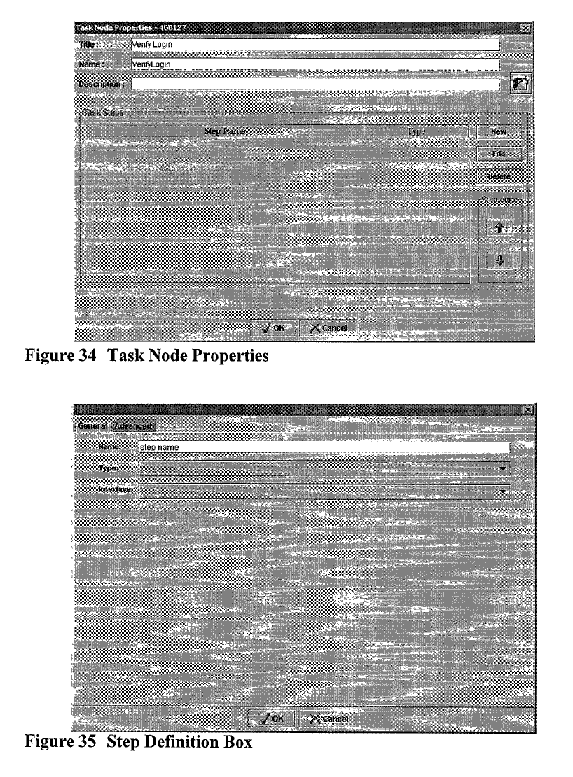

The Task node's properties dialog box is displayed. See FIG. 34.

2. Add a step.

A Task node can have as many steps as needed. The steps are applicationed in top down order.

Click New button.

The new step's definition box is displayed. See FIG. 35.

Step 3 Define the function of the step.

1. Specify a name for the step.

Type a name in the Name field.

For the sample case, Verify against database is used.

2. Select a function for the step.

Click on the Type drop down list and select from one of the choices.

For the sample case, Database is selected. See FIG. 36.

3. Select an interface.

Click on the Interface drop down list and select from one of the choices.

For the sample case, MS Verify Login is selected.

Once an interface is selected, the Interface area will appear.

Step 4 Create a DB List variable.

1. In the Interface area, click the New button.

A New Variable box is displayed.

2. Type a name for the new DB List variable.

For the sample case, the variable name is userinfo.

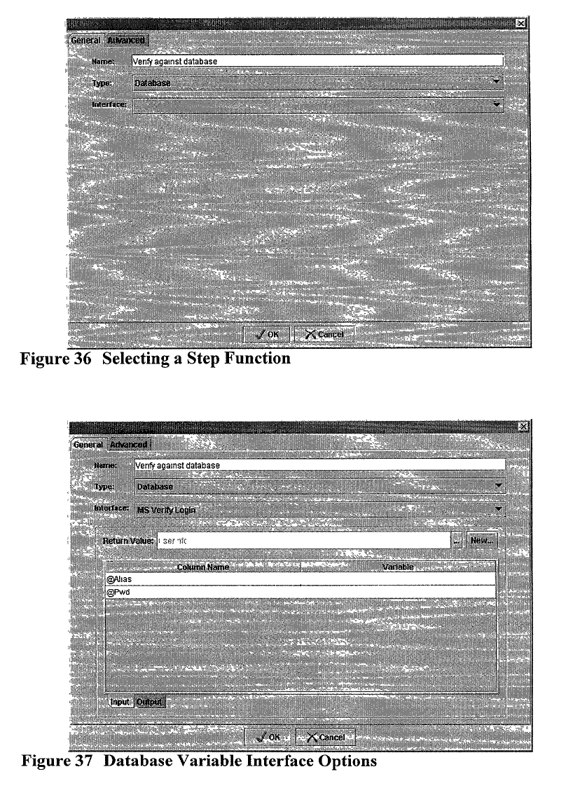

This name is displayed in the Return Value field. See FIG. 37.

3. Select a Return Value from the drop down list.

The Return Value is the predefined information that is returned from the database.

4. Enter Input and Output parameters, as needed.

The database interface set in the Interface field has it's own set of Input and Output requirements. These map to specific columns in the database records.

a. Click on the Variable field for each Input and Output Column Name.

A list of variables of matching type is displayed.

b. Scroll through the list and select a variable.

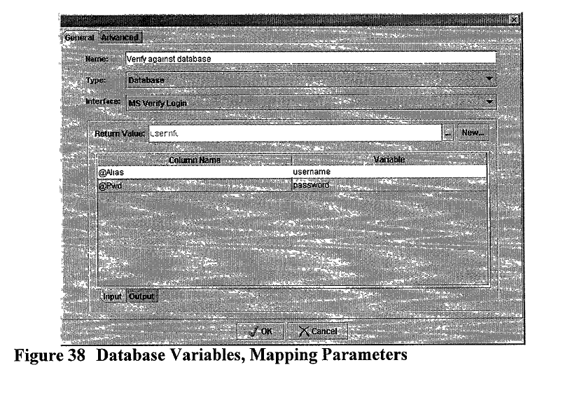

For the sample, the @Alias column name is mapped to the username variable, and @Pwd is mapped to the password variable. See FIG. 38.

### Setting Up for a Message Response

For an iterative response with the user it is necessary to define additional variables and components that can be used as temporary containers for the iterative actions.

For the sample case, the following items must be created:

Variable—blank, String type.

Component—UserNotFound, String type.

To create the variable, follow steps 1 and 2 under the Defining Variables section above.

To create the component, follow steps 4, 5, and 6 in the Defining User Interaction section above. When defining fields in the Component box, General tab, select blank as the variable, and Label as the UI Type. Do not set property values for the component yet. Those will be set later in the Data node.

### Setting Up a Condition

A decision node is used if it is desired for the application to proceed along a certain path only if selected conditions are met. Decision nodes are used to test for specific if/then conditions.

Step 1 Add a Decision node.

1. Go to the Node Palette, if visible, or the selection of nodes displayed on the tool bar.

2. Add a Decision node to the Application Diagram.

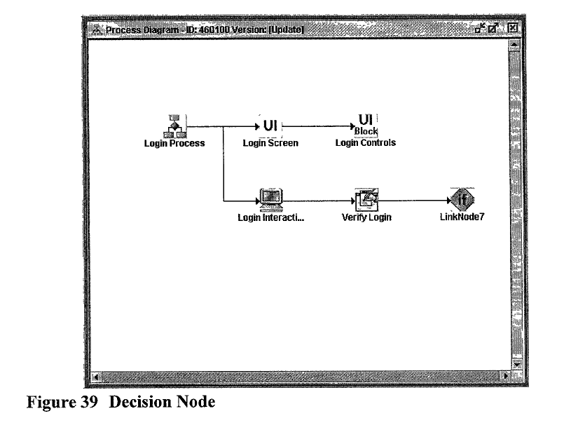

Click on the Decision node and drag it over the intended parent node. In the sample, the Task node, labeled Verify Login, is the parent node. See FIG. 39.

3. Double-click on the Decision node.

The Decision node's properties dialog box is displayed.

4. Type a title and name for the new node.

The sample title is Invalid User, and the sample name is InvalidUser.

5. Click OK.

Step 2 Define the Decision node conditions.

1. Open the Decision node's properties dialog box.

Double-click on the Decision node in the Application Diagram.

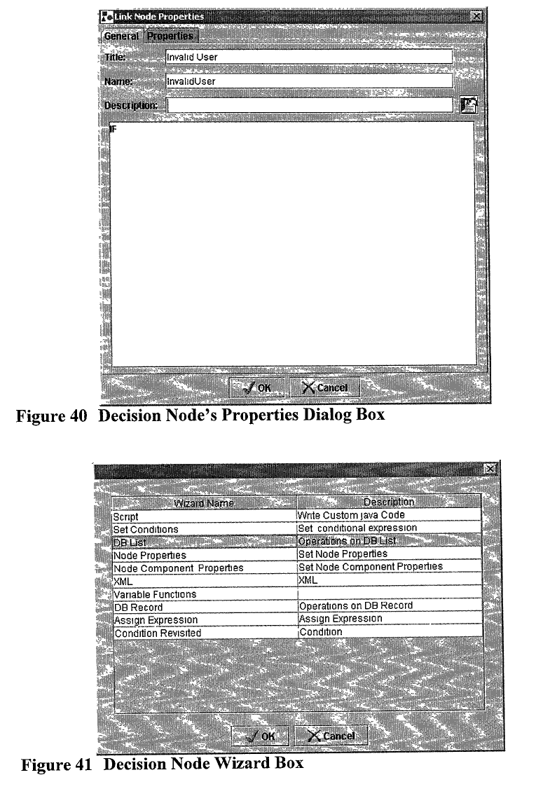

The Decision node's properties dialog box is displayed. See FIG. 40.

2. Right-click on the IF in the large text box.

A menu will appear with the options New and Expand Tree. elect New.

A Wizard box with a list of options is displayed. See FIG. 41.

3. Select one of the listed options.

For the sample case, DBList is selected.

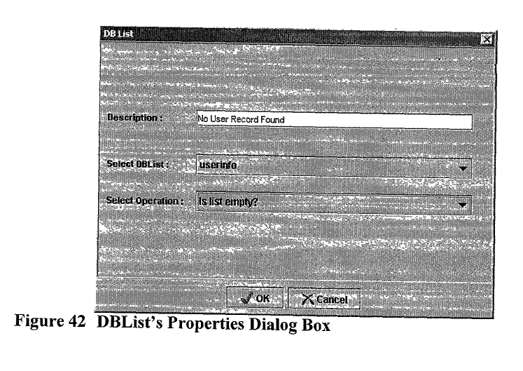

The DBList's properties dialog box will appear. See FIG. 42.

4. Enter a Description.

In the Description field, type a description of the condition.

For the sample case, No User Record Found is entered.

5. Select a DBList variable.

Under the click arrow in the Select DBList field is a list of variables that were created through the Task node.

Select one of the variables.

For the sample case, userinfo is selected.

6. Select an Operation.

Under the drop down list in the Select Operation field is a list of possible operations.

Select one of the Operations.

For the sample case, Is list empty? is selected.

7. Click OK

The conditions will appear in the Decision node's properties dialog box.

Once the condition is defined, the Data node is used to build expressions.

Step 1 Add a Data node.

1. Go to the Node Palette, if visible, or the selection of nodes displayed on the tool bar.

2. Add a Data node to the Application Diagram.

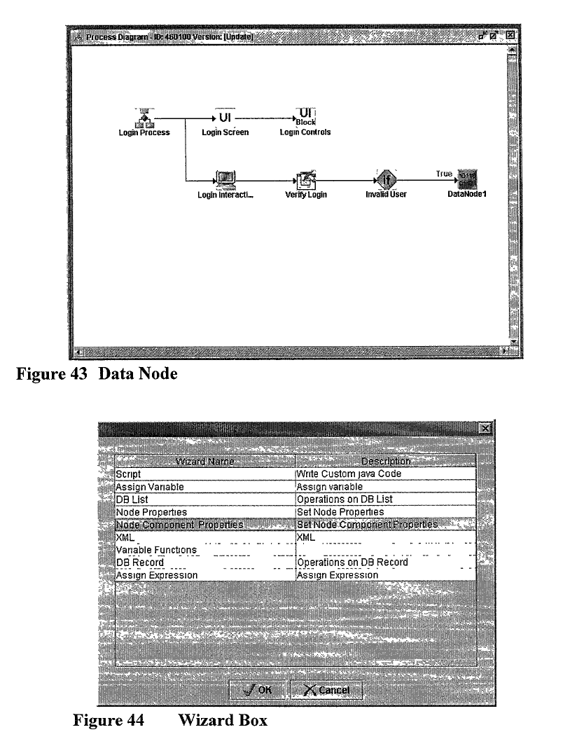

Click on the Data node and drag it over the intended parent node. In the sample, the Decision node, labeled Invalid User, is the parent node. See FIG. 43.

3. Double-click on the Data node.

The Data node's properties dialog box is displayed.

4. Type a title and name for the new node.

The sample title is Show Error Message, and the sample name is ShowErrorMessage.

5. Click OK.

Step 2 Define the Data node.

1. Open the Data node's properties dialog box.

Double-click on the Data node in the Application Diagram.

The Data node's properties dialog box is displayed.

2. Create Rules for the Data node.

b. Click New in the Rules Definition box.

The Wizard box is displayed. See FIG. 44.

c. Select a Wizard.

Click on the appropriate Wizard and click OK.

For the Sample case, Node Components Properties is selected.

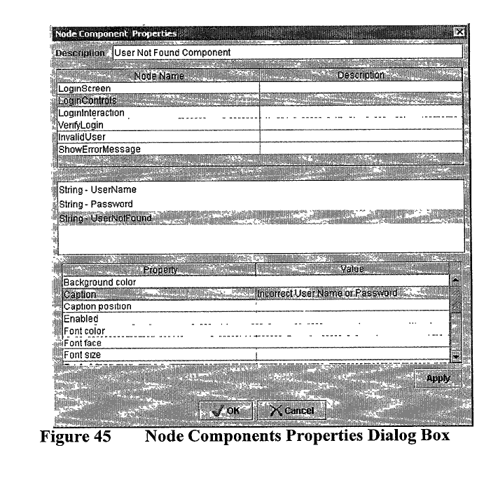

d. The Node Components Properties dialog box is displayed. See FIG. 45.

3. Enter a description.

In the Description field, type an appropriate description for the rule. For the sample case, User Not Found Component is entered as the description.

Step 3 Map the component to the Data node.

1. Map the rule to the User Interface Block node

Click on a User Interface Block node in the Node Name field.

2. Select a component.

Click on a component name.

For the sample case, String-UserNotFound is selected.

3. Define the properties of the component.

a. Enter text for the Caption property.

For the sample case, Incorrect User Name or Password is entered.

b. Select a value for the Visible property.

For the sample case, true is selected from the drop down list.

c. Click Apply.

The component property values are set.

d. Click OK.

returned to the Data node's properties dialog box.

4. Check the new rule.

In the Data node's properties dialog box, click Check.

This verifies that the rule has been defined correctly.

### Defining a Loop

Loops are a series of repeated steps. The beginning of a loop is specified as the last node a application runs before returning to an earlier part of the application. The point where it is desired for the application to return is the node that will have the loop node as its parent node.

Step 1 Add a Loop node.

1. Select a type of Loop node.

There are two types of loop nodes: While and Do While. For applications that require that the condition be checked before the loop begins, choose the While Loop. If it is desired that the condition is not checked until after the first loop, choose the Do While Loop.

For the sample case, the Do While Loop is selected.

2. Go to the Node Palette, if visible, or the selection of nodes displayed on the tool bar.

3. Add a Do While Loop node to the Application Diagram.

a. Drag the Do While Loop node over the intended parent node. In the sample, the Application node, labeled Login Application, is the parent node.

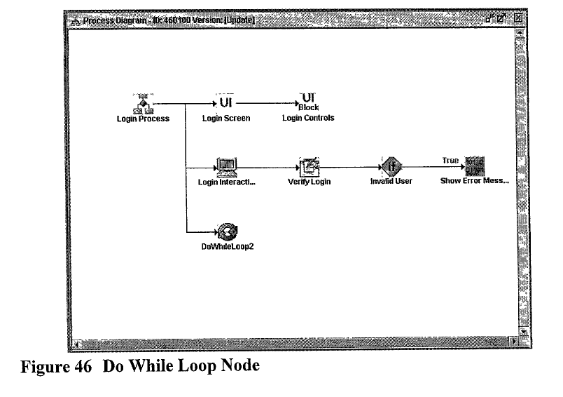

The Do While Loop node will appear on a lower branch. See FIG. 46.

b. Move the branch that will place the nodes in the loop application into the position of the Do While Loop node's children.

i. Copy the branch.

Right-click on the node to be placed immediately after the Do While Loop node and select Copy Branch.

For the sample case, the branch is copied from the Interaction node.

ii. Paste the branch.

Right-click on the Do While Loop node and select Paste.

The copied branch will appear.

iii. Remove the old branch.

Right-click on the node copied the branch from and select Delete. When the query is posed to delete the node and all of its children. Select OK.

For the sample case, delete from the old Interaction node.

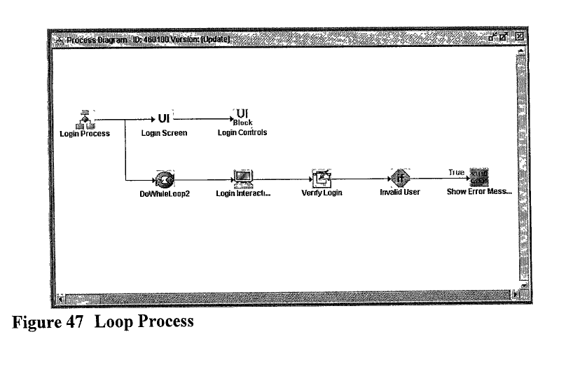

The application now contains a loop application. See FIG. 47.

iv. Reactivate the User Interface node in the Interaction node.

In the Interaction node's properties dialog box, select the User Interface node and click Add.

The user interface properties have been reactivated.

4. Double-click on the Do While Loop node.

The Do While loop's properties dialog box is displayed.

5. Type a title and name for the new node.

The sample title is User Not Found, and the sample name is UserNotFound.

6. Click OK.

Step 2 Define the Do While Loop node's conditions.

1. Open the Do While Loop node's properties dialog box.

Double-click on the Do While Loop node in the Application Diagram.

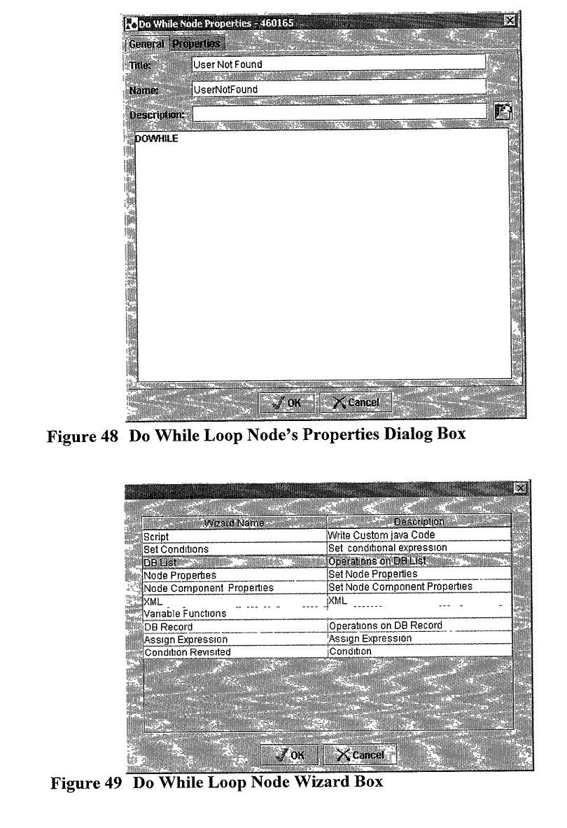

The Do While Loop node's properties dialog box is displayed. See FIG. 48.

2. Right-click on the DO WHILE in the large text box.

A menu will be displayed with the options New and Expand Tree.

Select New.

A Wizard box with a list of options is displayed. See FIG. 49.

3. Select one of the listed options.

For the sample case, DBList is selected.

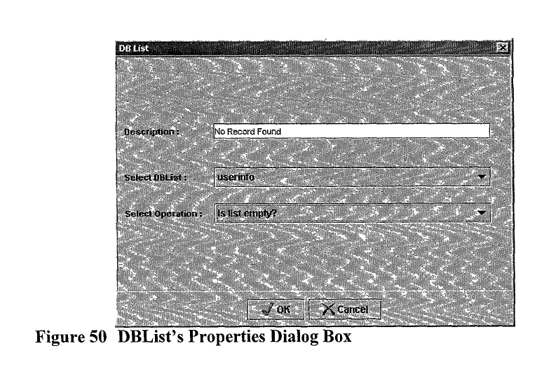

The DBList's properties dialog box will appear. See FIG. 50.

4. Enter a description.

In the Description field, type a description of the condition.

For the sample case, No Record Found is entered.

5. Select a DBList variable.

Under the drop down list in the Select DBList field is a list of variables that were created through the Task Node.

Select one of the variables.

For the sample case, userinfo is selected.

6. Select an Operation.

Under the click arrow in the Select Operation field is a list of possible operations.

Select one of the Operations.

For the sample case, Is list empty? is selected.

7. Click OK.

The conditions will appear in the Do While Loop node's properties dialog box.

### Saving the Application

At a few points while building the application, the application was saved.

Once the application is completed, save it again.

Step 1 Save the application.

1. Complete the application.

a. Right-click on the Application node.

For the sample case, the Application node is labeled Login application.

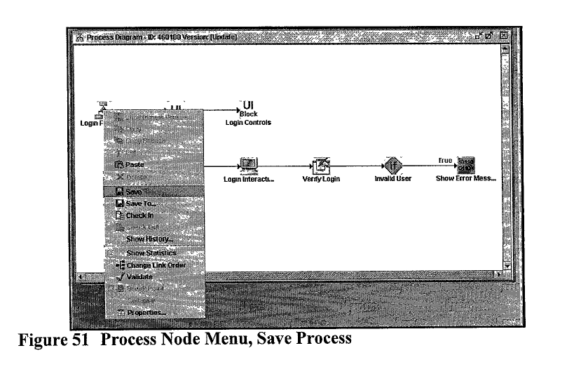

The Application node menu is displayed. See FIG. 51.

b. Select Save.

2. Find the Application node's ID.

Write down the ID that is displayed in the title of the Application Diagram.

### Testing the Application

Once the application is completed and saved, test it to be sure it is functioning correctly.

Step 1 Verify the application display on the website.

1. Open a web browser.

2. Determine the Intranet path to the Smart eBusiness URL. A URL example is: http://192.168.1.9/ispring/Default?handler=Start&applicationID=460100

3. Specify the application ID number found in SubStep 2b as the last six digits of the URL.

The web page for the application created is displayed.

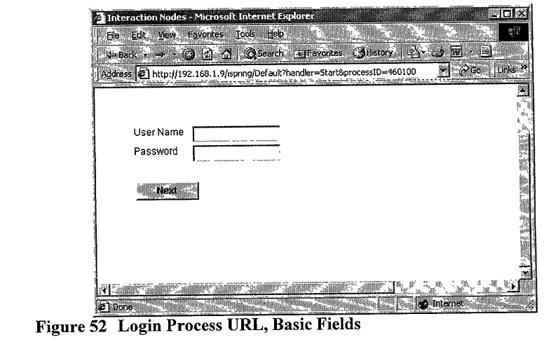

For the sample case, the two fields User ID and Password are displayed. See FIG. 52.

The foregoing description of a preferred embodiment of the invention has been presented for purposes of illustration and description. It is not intended to be exhaustive or to limit the invention to the precise forms disclosed. Obviously, many modifications and variations will be apparent to practitioners skilled in this art. It is intended that the scope of the invention be defined by the following claims and their equivalents.

What is claimed is:

1. A method for creating software, comprising:
providing a plurality of nodes and a directory of applications, each of an application being created by use of at least a portion of the plurality of the nodes;
selecting at least a portion of the plurality of nodes to create a selected node layout that represent a plurality of application logics; and
executing the selected node layout by a server program.

2. The method of claim 1, further comprising:
visually displaying the selected node layout as a visual node layout.

3. The method of claim 1, wherein at least a portion of the plurality of application logics includes a user interaction.

4. The method of claim 3, wherein the user interaction permits a user to interact with the server program.

5. The method of claim 3, wherein the user interaction is executable on multiple channels.

6. The method of claim 3, wherein the user interaction is executable by at least one of web, voice, e-mail and wireless channels.

7. The method of claim 1, wherein the plurality of nodes includes a user interface node.

8. The method of claim 7, wherein the user interface node includes GUI components and a template for the physical layout of static and dynamic portions of a user display.

9. The method of claim 8, wherein dynamic portions of the user display are used by the server program at runtime to layout application specific GUI components.

10. The method of claim 3, wherein the user interaction includes a user interface node, a user interface block node and an interaction node.

11. The method of claim 10, wherein the user interface node and user interface block node create a user interaction based on business rules.

12. The method of claim 11, wherein the interaction node executes the user interaction.

13. The method of claim 1, wherein each node is a visual representation of a software function.

14. The interface of claim 10, wherein each node includes inputs to a software function.

15. The interface of claim 1, wherein the plurality of nodes includes task node interfaces with external components to exchange data information.

16. The method of claim 1, wherein the selected node layout can be debugged visually

17. The method of claim 1, wherein the parameter and properties values of the nodes can be changed dynamically based on business rules

18. The method claim 1, wherein the parameter and properties values can be linked to variables

19. The method of claim 1, wherein the application logic is directly executed without compilation of application logic.

20. The method of claim 1, wherein the application logic can be paused and saved during execution

21. The method of claim 21, wherein the saved application logic can be restored and resumed.

22. The method of claim 22, wherein the saved application logic can be restored and execution resumed on a copy of the server program on a computer other than where it was initially started

23. A method for creating software, comprising:
providing a plurality of nodes and a directory of applications, each of an application being created by use of at least a portion of the plurality of the nodes;
selecting at least a portion of the plurality of nodes to create a selected node layout that represent a plurality of application logics;
defining the application logic by selecting at least one of GUI parameters and options in each selected node;
executing the selected node layout by a server program.

24. The method of claim 23, further comprising:
visually displaying the selected node layout as a visual node layout.

25. The method of claim 24, further comprising:
monitoring a flow of control through each node in the node layout during execution by displaying individual node execution measurements.

26. The method of claim 24, wherein the individual node execution measurements include usage counts, total execution time and average execution time.

27. The method of claim 23, further comprising:
providing documentation of a functional use of a node.

28. The method of claim 23, further comprising:
providing a graphic description of a plurality of nodes that represent a full application logic.

29. The method of claim 23, further comprising:
creating a history of different versions of the application logic.

30. The method of claim 23, further comprising:
creating access control of the application logic.

31. The method of claim 30, wherein the access control provides single access of the application logic for purposes of modification and multiple access of the application logic for purposes of viewing.

32. The method of claim 23, further comprising:
automatically validating the application logic against errors.

33. The method of claim 23, further comprising:
aggregation at least a portion of the plurality of nodes to create an aggregated node.

34. The method of claim 33, wherein the aggregated node is an application logic.

35. The method of claim 34, wherein the aggregated node can be used different application logics.

36. A method for creating software, comprising:
providing a plurality of nodes and a directory of applications, each of an application being created by use of at least a portion of the plurality of the nodes;
selecting at least a portion of the plurality of nodes to create a selected node layout that represent a plurality of application logics;
defining external application interfaces; and
executing the selected node layout by a server program.

37. The method of claim 36, further comprising:
establishing conditions for execution of the selected node layout.

38. The method of claim 37, wherein the conditions for the execution include time based events.

39. The method of claim 37, wherein the conditions for the execution include programmatic events.

40. The method of claim 39, wherein selected programmatic events create a trigger for the exeuction of the selected node layout.
